(19) United States
(12) Patent Application Publication
(10) Pub. No.: US 2021/0204137 A1
(43) Pub. Date: Jul. 1, 2021

(54) SECURE LOW POWER COMMUNICATIONS FROM A WIRELESS MEDICAL DEVICE TO MULTIPLE SMARTPHONES

(71) Applicant: Thirdwayv, Inc., Irvine, CA (US)

(72) Inventors: Nabil Wasily, Foothill Ranch, CA (US); Michael Atef Ayoub, Irvine, CA (US)

(21) Appl. No.: 17/057,816

(22) PCT Filed: May 22, 2019
(86) PCT No.: PCT/US2019/033575

§ 371 Date: Nov. 23, 2020

Related U.S. Application Data
(60) Provisional application No. 62/694,768, filed on Jul. 6, 2018.

(51) Int. Cl. H04W 12/50; H04W 76/14; H04W 48/10; H04W 8/00; G06F 1/14; H04W 12/086

(52) U.S. Cl. CPC H04W 12/50; H04W 76/14; H04W 48/10; H04W 76/15; G06F 1/14; H04W 12/086; H04W 8/005

(57) ABSTRACT

Methods, systems, devices and apparatuses for secure low power communication. The secure lower power communication system includes a medical device and one or more mobile devices. The medical device includes a memory, a network access device and one or more processors. The network access device has multiple hardware device addresses. The multiple hardware devices addresses include a first address and a second address. The network access device is configured to wirelessly communicate with a mobile device. The medical device includes one or more processors coupled to the memory and the network access device. The one or more processors are configured to execute instructions stored in the memory and perform operations. The operations include establishing first secure communication channel between the medical device and an application using the first address. The operations include transmitting advertising packets to remain discoverable by the application using the second address.

### CROSS-REFERENCE TO RELATED APPLICATIONS

This application claims priority to and the benefit of U.S. Provisional Patent Application No. 62/694,768 titled “SECURE LOW POWER COMMUNICATIONS FROM A WIRELESS MEDICAL DEVICE TO MULTIPLE SMARTPHONES,” filed on Jul. 6, 2018, and the entirety of which is hereby incorporated by reference herein.

### BACKGROUND

### 1. Field

This specification relates to a system, a device and/or a method for secure low power communications between a wireless medical device and one or more smartphones.

### 2. Description of the Related Art

Many Internet of Things (IOT) applications on IOT devices communicate with commercial smartphones to convey information to a smartphone application that is running in the background without user intervention. For example, a medical device, such as an insulin pump, or other embedded device may need to inform a user of an alarm condition that requires immediate attention.

Modern smartphone operating systems (OS) often prevent smartphone applications from running in the background without user involvement. These operating systems require a smartphone application to be in the foreground, i.e., actively being used by the user, to allow the app to communicate wirelessly with an embedded device, such as a medical device.

Smartphones allow applications in the background to automatically connect to wireless devices that were previously paired with the smartphone OS. The smartphone OS would record the wireless address of a given paired device and would continuously scan for the wireless address. Once the OS finds the wireless device transmitting, the OS will automatically connect to the wireless device and wake the application. This auto-connect, however, is not suitable for medical devices and other embedded devices which need to be controlled wirelessly by a smartphone at any time, as a medical device needs to be transmitting all the time, or at a high frequency, to allow for low latency in connecting and controlling the medical device. Due to the high availability of the medical device that is transmitting frequently, the smartphone OS would need to continuously connect with the medical device, which would cause high resource usage and consumption of the resources on the medical device.

Accordingly, there is a need for a system, a method and/or a device that establishes a secure robust communication between the medical device or other embedded device with a smartphone application while minimizing latency, power consumption and resource utilization.

### SUMMARY

In general, one aspect of the subject matter described in this specification is embodied in a device, a system and/or an apparatus for establishing a secure low power communication channel. The secure lower power communication system includes a medical device and one or more mobile devices. The medical device includes a memory, a network access device and one or more processors. The network access device has multiple hardware device addresses. The multiple hardware devices addresses include a first address and a second address. The network access device is configured to wirelessly communicate with a mobile device. The medical device includes one or more processors coupled to the memory and the network access device. The one or more processors are configured to execute instructions stored in the memory and perform operations. The operations include establishing a first secure communication channel between the medical device and an application using the first address. The operations include transmitting advertising packets to remain discoverable by the application using the second address.

These and other embodiments may optionally include one or more of the following features. The application may be running in a foreground environment of the mobile device when the secure communication channel is established using the first address. The first address may be a pairing address.

The operations may further include communicating to multiple applications running on multiple mobile devices using the first address. The multiple applications running on the multiple mobile devices may include a first application running on a first mobile device and a second application running on a second mobile device. The application running on the mobile device may be the first application and the mobile device may be the first mobile device. The second address may be an alternate address. The alternate address may remain unknown to the mobile device but discoverable to the application running on the mobile device.

The operations may include disconnecting the secure communication channel. The operations may include causing the application on the mobile device to run in a background environment of the mobile device when the application discovers the medical device transmitting the second address. The network access device may have a third address. The operations may include establishing a second secure communication channel with a second application using the third address. The establishment of the first secure communication channel and the second secure communication channel may be based on a whitelist or a blacklist of acceptable or unacceptable addresses, respectively. The operations may include transmitting the advertisement packets periodically using the second address to remain discoverable by the application. The operations may include limiting the communication to periodic low priority communications including status updates between the medical device and the application.

In another aspect, the subject matter is embodied in an embedded device. The embedded device includes a memory. The embedded devices includes a network access device. The network access devices has multiple identifiers. The multiple identifiers include a first identifier and a second identifier. The network access device is configured to wirelessly communicate with a first mobile device and a second mobile device. The embedded device includes one or more processors coupled to the memory and the network access device. The one or more processors are configured to execute instructions stored in the memory and perform operations that include establishing a secure communication channel between the embedded device and an application on the first mobile device using the first identifier. The operations include transmitting, using the second identifier, advertising packets to remain discoverable by the application. The operations include disconnecting the secure communication channel, and causing the application on the first mobile device to run in a background environment of the mobile device when the application discovers the embedded device using the second identifier.

In another aspect, the subject matter is embodied in a mobile device. The mobile device includes a memory configured to store multiple applications. The multiple applications include a first application and a second application. The first application is registered or associated with a first identifier and a second identifier. The second application is registered or associated with a third identifier and a second identifier. The mobile device includes a processor coupled to the memory configured to execute instructions stored in the memory and perform operations. The operations include executing the first application in the foreground. The operations include establishing a secure communication channel with an embedded device using the first identifier.

The operations include sending high priority communications to the embedded device over the secure communication channel, and discovering the embedded device using the second identifier.

### BRIEF DESCRIPTION OF THE DRAWINGS

Other systems, methods, features, and advantages of the present invention will be or will become apparent to one of ordinary skill in the art upon examination of the following figures and detailed description. It is intended that all such additional systems, methods, features, and advantages be included within this description, be within the scope of the present invention, and be protected by the accompanying claims. Component parts shown in the drawings are not necessarily to scale and may be exaggerated to better illustrate the important features of the present invention. In the drawings, like reference numerals designate like parts throughout the different views.

FIG. 1 is a block diagram of an example secure low power communication system according to an aspect of the invention.

FIG. 2 is a flow diagram of an example process implemented by the medical device of the secure low power communication system of FIG. 1 to establish the secure communication channel according to an aspect of the invention.

FIG. 3 shows the medical device of the secure low power communication system of FIG. 1 establishing a secure connection with one or more applications on the one or more mobile device of the secure low power communication system of FIG. 1 using multiple addresses according to an aspect of the invention.

FIG. 4 shows the medical device of the secure lower power communication system of FIG. 1 establishing a secure connection with one or more applications on the one or more mobile devices of the secure lower power communication system of FIG. 1 using multiple identifiers according to an aspect of the invention.

FIG. 5 is a flow diagram of an example process implemented by the one or more mobile devices of the secure low power communication system of FIG. 1 to establish the secure communication channel according to an aspect of the invention.

### DETAILED DESCRIPTION

Disclosed herein are systems, devices and methods for secure low power communications from a wireless medical device to multiple smartphones and/or smartphone apps. The secure low power communication system (“communication system”) establishes communication between a wireless embedded device (“embedded device”), such as a medical device, and one or more mobile devices, such as one or more smartphones or other personal device. The communication system 100 may establish the communication between the embedded device and one or more applications, such as a smartphone application (“application”), which runs or is executed on the mobile device, such as the smartphone, by the operating system (OS) of the mobile device, such as a smartphone OS. The embedded device may be a smart device, a medical device, or other embedded device, which may rely on over-the-air or wireless communication, to interact and communicate with the application running on the mobile device.

The embedded device may use multiple addresses to pair with an application running on a mobile device. By using multiple addresses, the embedded device may connect with the application when the application is in the foreground to establish a secure communication channel for the communication of high-priority and/or critical messages. Then, the embedded device may disengage the secure communication channel when the secure communication channel is no longer needed to reduce power consumption, reduce resource utilization and/or establish another secure communication channel with another application. The embedded device, however, may remain discoverable by the application when the application is in the background, by using a different address, which reduces latency in the establishment of a secure connection.

Other benefits and advantages include that the communication system implement secure functions to establish the secure communication channel between the embedded device and the one or more mobile devices. The secure functions may include use of a hash algorithm, using white lists and/or black lists, and/or shared secrets to secure communication between the embedded device and the one or more personal devices. This protects the messages and communications between the embedded device and the one or more personal devices from attacks, such as replay attacks.

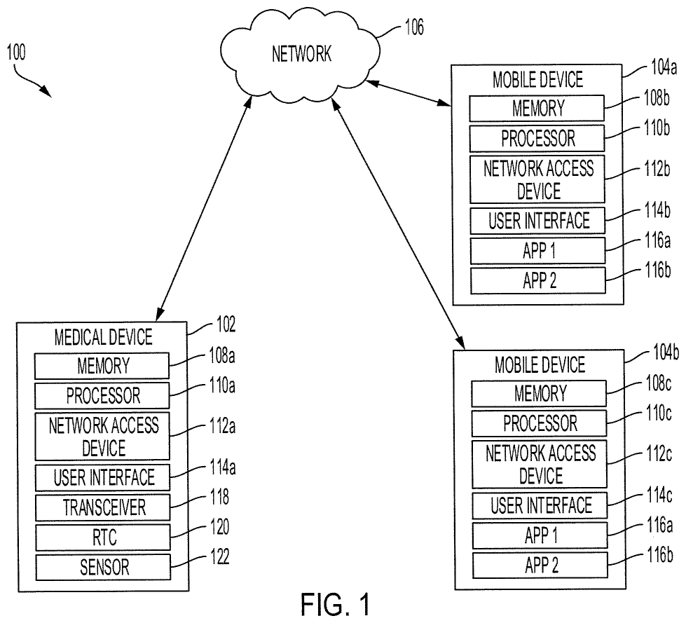

FIG. 1 shows a block diagram of a communication system 100. The communication system 100 includes an embedded device, such as a medical device 102, and one or more mobile devices 104a-b, such as a laptop, a tablet, a smartphone, a cellphone or other personal device. The communication system 100 may have a network 106 that links the medical device 102 and the one or more mobile devices 104a-b. The network 106 may be a local area network (LAN), a wide area network (WAN), a cellular network, the Internet, other wired or wireless communication, combination thereof, that connects, couples and/or otherwise communicates between the various components of the communication system 100, such as the medical device 102 and/or the one or more mobile devices 104a-b.

The medical device 102 establishes communication with the one or more mobile devices 104a-b. The medical device 102 may establish communication with multiple applications on each of the one or more mobile devices 104a-b. The medical device 100 uses multiple addresses, multiple universally unique identifiers (UUIDs) or other addresses or identifiers to connect with different applications on the one or more mobile devices 104a-b. The multiple mobile devices 104a-b may include different mobile devices 104a-b, such as a first smartphone for a first user and a second smartphone for a second user.

The medical device 102 includes a memory 108a, one or more processors 110a, and/or a network access device 112a. The medical device 102 may include a user interface 114a, a transceiver 118, a real-time clock (RTC) 120, and/or a sensor 122. The memory 108a may store instructions that are executed by the one or more processors 110a to execute critical functions of the medical device 102, such as the administration or delivery of insulin or other medication or prescription. The memory 108a may store a shared-secret that is used in establishing a secure communication channel with the one or more mobile devices 104a-b. The memory 108a may store one or more associations between the multiple hardware addresses or identifiers (“addresses or identifiers”) used by the network access device 112a to connect with the one or more applications 116a-b running on the one or more mobile devices 104a-b. The medical device 102 may use the one or more associations to select the address or identifier to use to transmit to a corresponding application 116a-b on a corresponding mobile device 104a-b to connect with the corresponding application 116a-b.

The processor 110a is coupled to and executes instructions stored within the memory 108a. The processor 110a may process an activation request to activate the medical device 102 and allow the transmission of one or more communications via the one or more network access devices 112a-c. Additionally, the processor 110a determines or selects the one or more applications 116a-b that the medical device 102 is to communicate with and selects one or more addresses or identifiers to use to transmit and establish the communication with the one or more applications 116a-b. The processor 110a may also connect, receive and/or execute the high priority communications to/from the one or more applications 116a-b when a secure communication channel is established via the one or more network access devices 112a-c and/or provide the low priority communications to the one or more applications 116a-b.

The medical device 102 includes a network access device 112a to communicate with the one or more mobile devices 104a-b via the network 106. The network access device 112 may be coupled or connected to the processor 110a. The processor 110a uses the network access device 112a to establish the secure communication channel and to send and/or receive communication to the one or more applications 116a-b on the different mobile devices 104a-b. The medical device 102 may have a user interface 114a. The user interface 114a provides an interface for a user to provide user input, such as an activation request. The activation request may activate the medical device 102 and allow for the transmission between the medical device 102 and one or more mobile devices 104a-b.

The medical device 102 may have a transceiver 118, such as a near field communication transceiver. When the transceiver 118 is in proximity or within a threshold distance of a near field communication transceiver, the transceiver 118 may send an activation request to the processor 110a to trigger activation of the medical device 102 and allow for wireless transmission.

The medical device 102 may have one or more real time clocks (RTCs) 120 and a sensor 122. The RTC may have a low-power clock oscillator and send a periodic signal to the sensor 122. The RTC may be configured to periodically activate between predetermined period. The sensor 122 may use the periodic signal to measure an amount of time that has elapsed and/or be triggered by the periodic signal to measure a feature of the user, such as the temperature or amount of glucose level, for example.

The communication system 100 includes one or more mobile devices 104a-b. The one or more mobile devices 104a-b each include a memory 108b-c, a processor 110b-c, a network access device 112b-c and/or a user interface 114b-c. The one or more mobile devices 104a-b may be a smartphone, a cellphone, a tablet or other portable personal device. The one or more mobile devices 104a-b may each have one or more applications 116a-b that are stored within the memory 108b-c and are executed by the processor 110b-c.

The one or more memories 108b-c may each store instructions that are executed by the one or more processors 110b-c, respectively. Moreover, the one or more memories 108b-c may store one or more applications 116a-b that are loaded, unloaded or otherwise executed by the one or more processors 110b-c of the one or more mobile devices 104a-b, respectively. In some implementations, the one or more memories 108b-c may store a shared secret that is used by the one or more processors 110a-c to establish a secure communication channel between the one or more applications 116a-b and the medical device 102.

The one or more processors 110b-c may be coupled or connected to the one or more memories 108b-c, respectively. The one or more processor 110b-c execute the instructions stored in the one or more memories 108b-c and/or run the one or more applications 116a-b. The one or more processors 110b-c use the one or more network access devices 112b-c to connect the one or more applications 116a-b with the medical device 102. Moreover, the one or more processors 110b-c may obtain user input that is inputted through the one or more user interfaces 114b-c into the one or more applications 116a-b and issue, provide or receive communications to and from the medical device 102 via the one or more network access devices 112a-c.

The one or more network access devices 112b-c may be coupled to the one or more processors 110b-c. The one or more network access devices 112b-c establish communication with the other network access device 112a to securely connect the one or more applications 116a-b with the medical device 102. The one or more mobile devices 104a-b may include one or more user interfaces 114b-c. The one or more user interfaces 114b-c may obtain user input and/or provide status updates to and/or from the medical device 102. The user input may include critical commands and/or functions that are sent to the medical device 102 when a secure communication channel is established. The critical commands and/or functions may be a command to administer insulin, medication and/or a prescription, for example. Moreover, the one or more user interfaces 114b-c may provide or display status updates that are received or obtained from the medical device 102.

The one or more processors 110a-c may each be implemented as a single processor or as multiple processors. The one or more processors 110a-c may be electrically coupled to, connected to or otherwise in communication with the corresponding memory 108a-c and/or network access device 112a-c and/or user interface 114a-c on the respective device, such as the medical device 102 and/or the one or more mobile devices 104a-b.

The one or more memories 108a-c may be coupled to the one or more processors 110a-c and store instructions that the processors 110a-c execute. The one or more memories 108-c may include one or more of a Random Access Memory (RAM) or other volatile or non-volatile memory. The one or more memories 108a-c may be a non-transitory memory or a data storage device, such as a hard disk drive, a solid-state disk drive, a hybrid disk drive, or other appropriate data storage, and may further store machine-readable instructions, which may be loaded and executed by the one or more processor 110a-c. Moreover, the one or more memories 108a-c may be used to store one or more applications 116a-b, such as a medical application.

The one or more user interfaces 114a-c may include any device capable of receiving user input, such as a button, a dial, a microphone, or a touch screen, and any device capable of output, e.g., a display, a speaker, or a refreshable braille display. The one or more user interfaces 114a-c allow a user to communicate with the one or more processors 110a-c, respectively. For example, the user may provide user input to activate the medical device 102 or the processor 110 may display status information about the medical device 102 to the user on the one or more mobile devices 104a-b.

The one or more network access devices 112a-c may include a communication port or channel, such as one or more of a Wi-Fi unit, a Bluetooth® unit, a radio frequency identification (RFID) tag or reader, or a cellular network unit for accessing a cellular network (such as 3G, 4G or 5G). The one or more network access device 112a-c may transmit data to and receive data among the one or mobile devices 104a-b and the medical device 102.

The one or more mobile devices 104a-b include one or more applications 116a-b. The one or more processors 110b-c may execute the one or more applications 116a-b on the one or more mobile devices 104a-b. The one or more applications 116a-b may include multiple applications 116a-b, such as a first application 116a and/or a second application 116b. The one or more applications 116a-b may include a medical device application that controls the medical device 102 or other smartphone application. For example, the medical device application may issue critical commands and/or functions, such as the administration of a medication and/or prescription, using the one or more applications 116a-b to control the medical device 102.

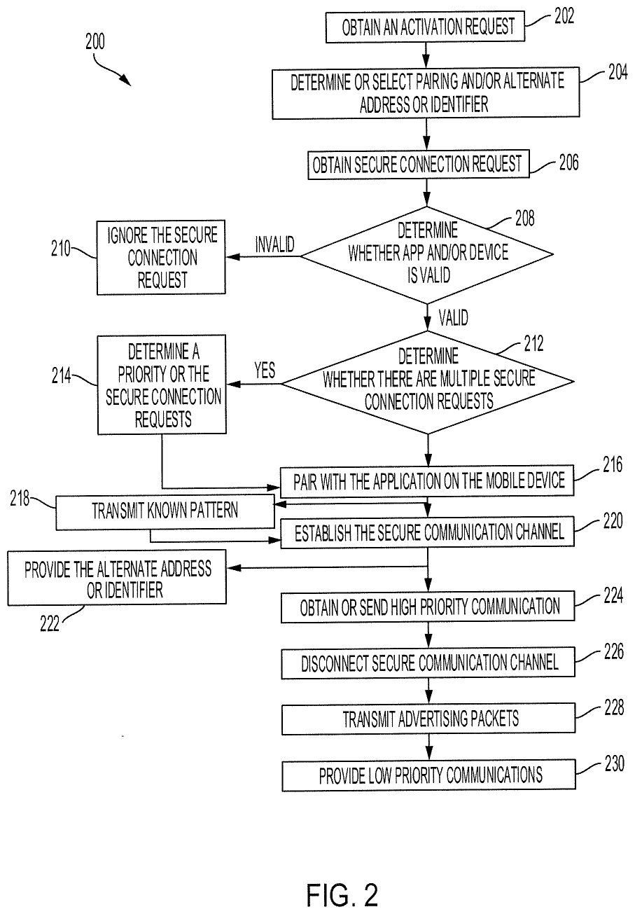

FIG. 2 is a flow diagram of an example process 200 for establishing the communication between the medical device 102 and the one or more mobile devices 104a-b. One or more computers or one or more data processing apparatuses, for example, the processor 110a of the medical device 102 of communication system 100 of FIG. 1, appropriately programmed, may implement the process 200.

The medical device 102 may obtain an activation request (202). The activation request is a request to activate wireless transmissions on the medical device 102 to transmit or otherwise send and/or receive communications. The communications may include high priority communications and/or a low priority communications. A high priority communication is a command to perform a critical function, such as the administration of a drug, such as insulin, prescription or other treatment by the medical device 102 to a patient or other user of the medical device 102, or a critical notification of a critical function. A low priority communication is a status update, advertisement, acknowledgement or other informative communication that may be used to notify the user or application of the status of the medical device 102 so that the medical device 102 may remain discoverable to the one or more mobile devices 104a-b.

The medical device 102 may receive user input via the user interface 114a that includes the activation request. For example, when a user pushes, toggles or otherwise moves a button, the user interface 114a provides and the processor 110a receives an activation request to activate, turn on, or otherwise initialize the network access device 112a to allow wireless transmission of communications by the medical device 102.

In some implementations, the medical device 102 has a transceiver 118, such as a near field communication (NFC) transceiver. The transceiver 118 may detect when a near field communication field is in proximity or within a threshold distance, such as within a few feet, of the medical device 102. When the transceiver is in proximity or within the threshold distance, the transceiver 118 sends and the processor 110a receives the activation request.

In other implementations, the medical device 102 may have and use a real time clock (RTC) 120 and sensor 122 to detect that a period of time has elapsed. The RTC 120 may periodically send a signal and the sensor 122 may measure and use the signal to determine an amount of elapsed time from when the RTC was initialized. When the sensor 122 determines that the amount of elapsed time is greater than or equal to a threshold amount, the sensor 122 may send the activation request to the processor 110a. In some implementations, when the RTC 120 sends the signal the sensor 122 may take a measurement of the user's body. For example, the sensor 122 may measure the temperature or glucose level of the user's body. When the measurement exceeds a threshold value, such as a threshold temperature or glucose level, the sensor 122 may send the activation request to the processor 110a.

By waiting for the activation request before connecting, communicating or otherwise transmitting to and/or receiving from one or more applications 116a-b, the medical device 102 may minimize power consumption when the medical device 102 is on the shelf, for example. The activation request triggers to the medical device 102 to wake from the low power consumption state and start transmission.

Once the medical device 102 is activated, the medical device 102, the medical device 102 determines, selects and/or transmits a pairing address or identifier to establish the secure communication channel and an alternate address or identifier to use to remain discoverable by the one or more applications 116a-b on the one or more mobile devices 104a-b (204). The determination or the selection may be based on user input, which may indicate an application and/or mobile device to connect with or based on a pre-configured selection of the addresses or identifiers.

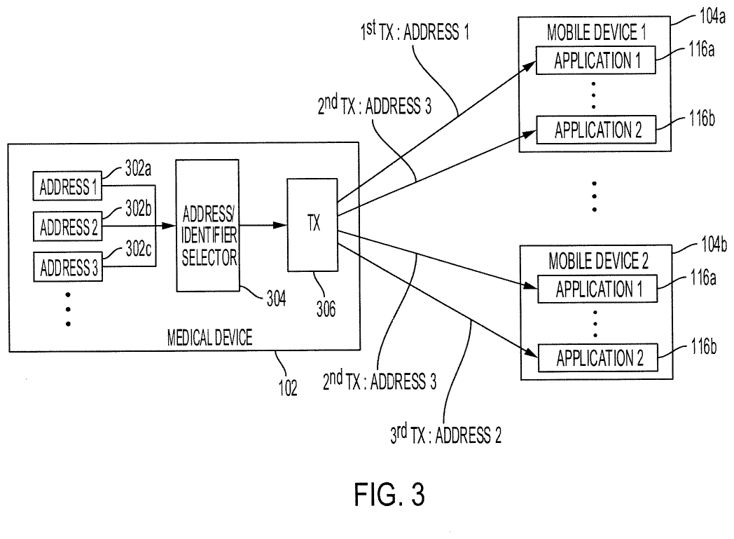

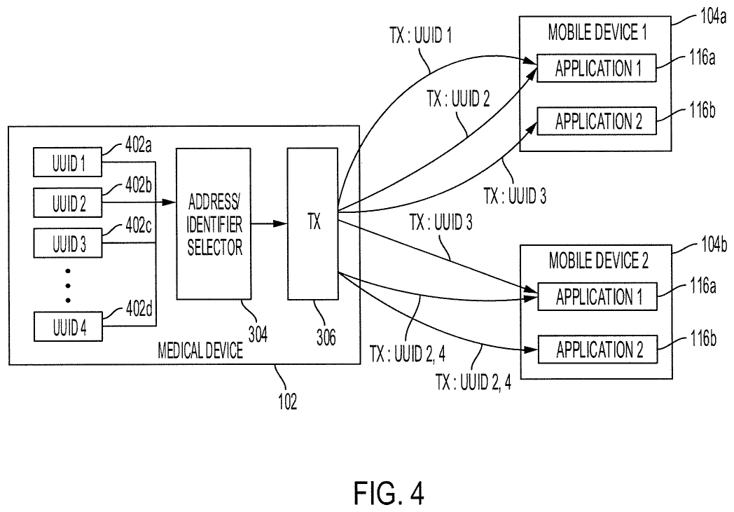

The network access device 112a may have multiple hardware device addresses, such as the addresses 302a-c, as shown in FIG. 3 for example, and/or multiple identifiers, such as one or more universally unique identifiers (UUIDs) 402a-c, as shown in FIG. 4, for example. The memory 108a may store one or more associations between each of the multiple addresses and/or identifiers with an application identifier associated with an application 116a-b and/or mobile device identifier associated with a mobile device 104a-b. The processor 110a may determine the pairing and/or alternate address and/or identifier associated with the application identifier and/or mobile device identifier of the application and/or mobile device, respectively, using the stored associations.

When the one or more mobile devices 104a-b scan and attempts to connect to the medical device 102 using the pairing address or identifier, the medical device 102 obtains one or more secure connection requests from one or more applications 116a-b on one or more mobile devices 104a-b (206). A secure connection request may be a request by an application 116a-b on a mobile device 104a-b to securely connect with the medical device 102 to send and/or receive high priority communications. The secure connection request may include an application or device identifier that indicates that application and/or mobile device that that is requesting the secure connection.

The medical device 102 may receive multiple secure connection requests simultaneously or within a time-period. The multiple secure connection requests may come from multiple different applications on a single mobile device 104a-b, multiple different applications on multiple mobile devices 104a-b or from the same type of application on different multiple mobile devices 104a-b.

For each of the one or more secure connection requests, the medical device 102 determines whether the application and/or mobile device sending the secure connection request is valid (208). The medical device 102 may extract the application or device identifier that indicates which application and/or mobile device is requesting the secure connection. The medical device 102 may compare the application or device identifier to a blacklist or a whitelist. The blacklist is list of applications or devices that are not permitted to communicate with the medical device 102. The whitelist is a list of applications or devices that are permitted to communicate with the medical device 102. The one or more lists may be stored in the memory 108a and may have been pre-stored and/or user-inputted. The one or more lists may be updated when the medical device 102 securely connects with an application 116a-b. In some implementations, the medical device 102 may check and/or require that both an application and device identifier are included in the secure connection request and are on the whitelist or not on the blacklist, respectively.

If the application and/or device identifier is on the blacklist or not on the whitelist, respectively, the medical device 102 may determine that the application and/or mobile device is invalid and ignore the secure connection request from the application 116a-b and/or block the one more mobile devices 104a-b from communicating with the medical device 102 (210). This prevents unauthorized applications and/or mobile devices from accessing the medical device 102.

If the application and/or the device identifier is not on the blacklist or is on the whitelist, respectively, the medical device 102 may determine that the one or more applications 116a-b and/or the one or more mobile devices 104a-b are valid. In response, the medical device 102 allows the one or more applications 116a-b and/or the one or more mobile devices 104a-b to communicate with the medical device 102.

Once the applications and/or medical devices are validated, the medical device 102 may determine which of the one or more multiple secure connection requests from the multiple applications to establish the connection. The medical device 102 determines whether there are multiple secure connection requests (212). The multiple secure connections requests may be received or obtained simultaneously or over a period of time.

If there are multiple secure connection requests, the medical device 102 may determine a priority for each of the secure connection requests (214). The priority may be based on an ordering of when the one or more secure connection requests are received. For example, a secure connection request that is received earlier than another secure connection request may be given priority over the other secure connection request so that the medical device 102 connects with the application that sent the earlier secure connection request. In some implementations, the medical device 102 may prioritize based on the application or device identifier. For example, the medical device 102 may prioritize an application that administers a prescription and is originating from the doctor over an application that is checking status and is originating from a non-medical personnel.

The medical device 102 pairs with the application 116a-b on the one or more mobile devices 104a-b (216). The medical device 102 uses the pairing address or identifier to pair with the one or more applications 116a-b and to establish the secure communication channel. The medical device 102 may pair with a single application 116a-b on a single mobile device 104, multiple applications 116a-b on a single mobile device 104a-b, multiple applications 116a-b of the same application on different mobile devices 104a-b and/or multiple different applications 116a-b on the different mobile devices 104a-b. This allows the medical device 102 to selectively communicate with a given app at any given time, by selectively using the pairing address or identifier to pair with a corresponding mobile device 104a-b. Moreover, by using the same pairing address or identifier, the medical device 102 may broadcast information to a group of applications 116a-b or mobile devices 104a-b at the same time.

In some implementations, the medical device 102 may alternate between selecting a first pairing address or identifier that is associated with multiple applications 116a-b, i.e., a group pairing address or identifier, and a second pairing address or identifier that is associated with a single application 116a-b, i.e., an individual pairing address or identifier, to alternate communication between a group of applications and a single application.

During the pairing process, the medical device 102 may derive or generate a unique shared secret (“shared secret”). The medical device 102 may store the shared secret in the memory 108a so that the processor 110a may later use the shared secret to compute a message authentication code (MAC) that is used to authenticate transmissions between the medical device 102 and the one or more applications 116a-b and/or the one or more mobile devices 104a-b.

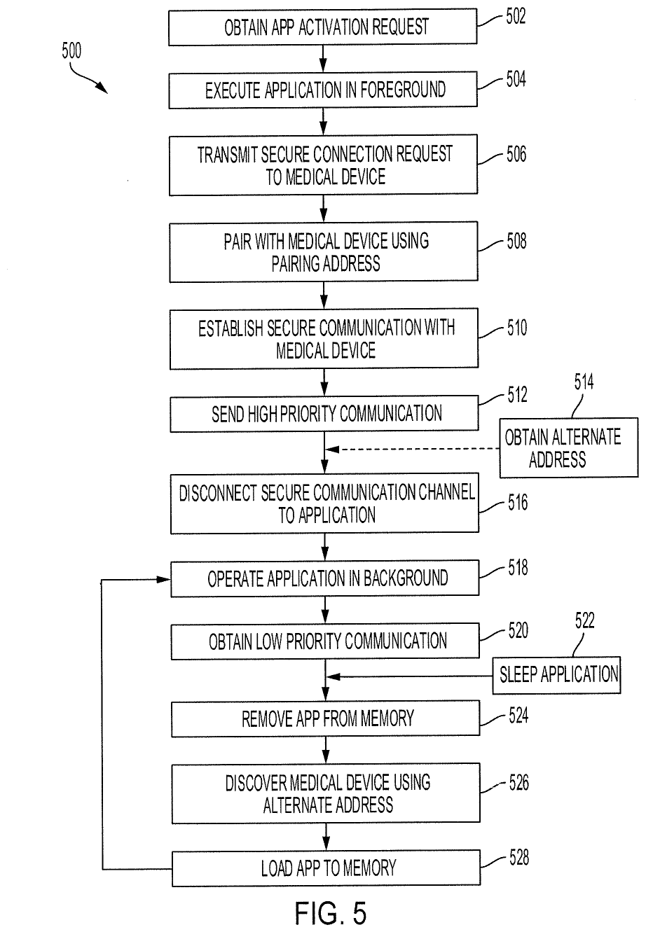

In some implementations, the medical device 102 may transmit a known pattern in the transmissions (218). This known pattern is known by the one or more applications 116a-b on the one or more mobile devices 104a-b and is used by the one or more applications 116a-b to scan for the medical device 102 when the one or more applications 116a-b are in the foreground environment, regardless of the pairing address or identifier that the medical device 102 is currently transmitting. If the one or more applications 116a-b fail to respond to the transmissions, the medical device 102 may change the format of the transmissions to wake up one or more applications 116a-b, which may have been unloaded from the memory 108a-b. Once woken, the one or more mobile devices 104a-b restore the one or more applications 116a-b to the memory 108a-b. The medical device 102 may use an alternate address or identifier, such as a UUID registered with the one or more applications 116a-b, to wake the one or more applications 116a-b. FIG. 5 further describes the process of waking the one or more applications 116a-b.

The medical device 102 establishes a secure communication channel with the application 116a-b on the one or more mobile devices 104a-b when paired with the application 116a-b (220). The medical device 102 may use the shared secret known to the medical device 102 and the one or more applications 116a-b to compute the MAC, which the medical device 102 includes with the transmissions to the one or more applications 116a-b that are paired with the medical device 102. The use of the MAC provides authentication and confidentiality of the transmission to the application 116a-b, which prevents fake or unintentional transmissions to the application 116a-b. A random nonce and/or a monotonically increasing sequence number may be included with the MAC in the transmissions to avoid replay attacks.

The medical device 102 may provide the alternate address or identifier to the one or more applications 116a-b (222). The medical device 102 uses the alternate address or identifier to interact with one or more applications 116a-b in the background environment of the one or more mobile devices 104a-b. This allows the medical device 102 to remain discoverable to the one or more applications 116a-b in the background environment when the medical device 102 uses the alternate address or identifier.

Once the secure communication channel is established, the medical device 102 may obtain and/or transmit high priority communications (224). The high priority communications include critical commands, critical functions, critical notifications or other instructions that control, operate or otherwise manipulate the medical device 102. For example, the critical commands or instructions may instruct the medical device 102 to administer a medication, such as insulin, prescription or other treatment to a patient. In another example, the critical commands or instructions may include a schedule, user feedback regarding the medication, prescription or the treatment or other related information associated with the medication, prescription or treatment and/or the administration of the medication, prescription or treatment. Other examples of critical commands or instructions may include the manipulation of the functionality of the medical device 102, such as the adjustment of a system clock, an update of the firmware or associated software, or other related tasks that effect operation of the medical device 102. In one example of a critical notification, the medical device 102 may alert a doctor when a drug, prescription or other treatment has been or is being administered and/or alert the doctor of the type of drug, prescription or other treatment that has been or is being administered.

The medical device 102 may disconnect the secure communication channel using the pairing address or identifier when the one or more applications 116a-b are connected end communications or otherwise disconnect from the medical device 102 (226). When a user switches from one application to another, such as when an application is moved from the foreground environment to the background environment, or otherwise leaves or exits the application that is connected to the medical device 102, the medical device 102 may disconnect or otherwise disengage the secure communication channel, which prevents high priority communication between the medical device 102 and the one or more applications 116a-b.

The medical device 102 may remain discoverable and communicate or otherwise transmit advertising packets using the alternate address or identifier even when the secure communication channel is no longer established (228). The medical device 102 may remain discoverable, communicate or otherwise transmit the advertising packets periodically. The medical device 102 may use the alternating address or identifier to communicate with the one or more applications 116a-b in the background environment regardless of whether the secure communication channel with the one or more applications 116a-b is established in the foreground environment.

In some implementations, the medical device 102 sends a broadcast message within the advertisement packets to multiple applications 116a-b on one or more mobile devices 104a-b. The medical device 102 may transmit the broadcast message to the multiple applications 116a-b simultaneously.

In some implementations, the medical device 102 alternates between using the pairing address or identifier and the alternate address or identifier to establish the secure communication or remain discoverable, respectively. The medical device 102 may alternate between the pairing address or identifier and the alternate address or identifier periodically to enable a periodic connection between the medical device 102 and a given application 116a-b. Moreover, this avoids operating system filtering due to duplicate discovery of the same address.

The medical device 102 may use the alternate address or identifier to remain discoverable to multiple different applications 116a-b on multiple different mobile device 104a-b, regardless of whether a secure communication channel was previously established with the medical device 102.

The transmission of the advertising packets may cause one or more applications 116a-b to wake or otherwise initialize after the one or more applications 116a-b have been unloaded from the one or more memories 108a-b. When the one or more applications 116a-b wake-up, the one or more mobile devices 104a-b may reload the one or more applications 116a-b into the one or more memories 108a-b. FIG. 5 further describes the interactions of the one or more applications 116a-b and the one or more mobile devices 104a-b.

When the medical device 102 is discovered, the medical device 102 may provide low priority communications to the one or more applications 116a-b on the one or more mobile devices 104a-b (230). The low priority communications may include status updates, such as the health of the hardware and/or software of the medical device 102, and/or notifications that notify the one or more applications 116a-b and/or the one or more mobile devices 104a-b that the medical device 102 is alive and in proximity to the one or more applications 116a-b and/or the one or more mobile devices 104a-b. In some implementations, the medical device 102 limits communication to outbound communication of the low priority communications. That is, the medical device 102 filters or otherwise blocks any communication received from the one or more applications 116a-b and/or the one or more mobile devices 104a-b.

FIG. 3 shows the medical device 102 communicating with one or more applications 116a-b on the one or more mobile device 104a-b using multiple addresses 302a-c. FIG. 4 shows the medical device 102 communicating with the one or more applications 116a-b on the one or more mobile devices 104a-b using multiple identifiers 402a-c. The medical device 102 has a network access device 112a, which has and assigns one or more addresses or identifiers, such as the addresses 302a-c or the identifiers 402a-c, to use to connect with the one or more applications 116a-b on the one or more mobile devices 104. The addresses 302a-c may be an International Mobile Equipment Identity (IMEI) number or a Bluetooth Low Energy (BLE) Media Access Control (MAC) address. The identifiers 402a-c may be a TrustZone Identifier (ID) or a Universally Unique Identifier (UUID).

The medical device 102 may have an address/identifier selector module 304 and a transceiver module 306. The address/identifier selector module 304 may select a first address and/or a second address from the one or more addresses 302a-c, as shown in FIG. 3 for example, or a first identifier and/or a second identifier from the one or more identifiers 402a-c, as shown in FIG. 4 for example. The medical device 102 uses the addresses and/or identifiers to establish a secure communication with the one or more applications 116a-b when the one or more applications 116a-b are in the foreground environment and to remain discoverable when the one or more applications 116a-b are in the background environment.

In one aspect, as shown in FIG. 3, the medical device 102 may use an address to pair with multiple different applications on multiple different mobile devices, multiple different applications on the same mobile device and/or the same type of application on multiple different mobile devices. For example, the address/identifier selector module 304 may select the address 302a when pairing and establishing communication with the application 116a on the mobile device 104a. Then, the transceiver module 306 uses the address 302a to pair and establish the communication with the application 116a on the mobile device 104a. Similarly, the address/identifier selector module 304 may select the address 302b and the transceiver may use the address 302b when pairing and establishing the communication with the application 116b on the mobile device 104b.

In some implementations, the medical device 102 uses the same address to communicate with the same type of application 116b on different mobile devices 104a-b. For example, the address/identifier selector module 304 may select the address 302c to communicate with the application 116b on the mobile device 104a and/or the mobile device 104b. The transceiver module 306 may send a broadcast message that sends the communication using the address 302c to both the application 116b on the mobile device 104a and the application 116b on the mobile device 104b or may pair with the application 116b on a single mobile device 104a or 104b based on a priority, as described above.

In another aspect, as shown in FIG. 4, the medical device 102 may use a UUID to pair with multiple different applications on multiple different mobile devices, multiple different applications on the same mobile device and/or the same type of application on multiple different mobile devices. For example, the address/identifier selector module 304 may select the UUID 402a when pairing and establishing communication with the application 116a on the mobile device 104a. Then, the transceiver module 306 uses the UUID 402a to pair and establish the communication with the application 116a on the mobile device 104a. The address/identifier selector module 304 may select the UUID 402c and the transceiver may use the 402c to send a multicast message to different applications 116a-b on the same mobile device 104a-b or different mobile devices 104a-b, which are registered to the UUID 402c. In another example, the address/identifier selector module 304 may select the UUID 402b to pair and establish the communication with the application 116a and the application 116b on the mobile device 104b. Each application 116a-b may be registered to one or more UUIDs on each of the one or more mobile devices 104a-b.

FIG. 5 is a flow diagram of an example process 500 for establishing communication with the medical device 102. One or more computers or one or more data processing apparatuses, for example, the processor 110b-c of the one or more mobile devices 104a-b of communication system 100 of FIG. 1, appropriately programmed, may implement the process 500.

The one or more mobile devices 104a-b may include a single mobile device 104a or 104b or multiple mobile devices 104a-b. The mobile device 104a-b may obtain an application activation request (502). The application activation request may be user input on the user interface 114b-c of the one or more mobile devices 104a-b, which requests initialization or activation of one of the one or more applications 116a-b. For example, a user may select an application shortcut or icon, which causes the processor 110b-c to execute and initialize the selected application 116a-b.

In response to the activation request, the mobile device 104a-b executes the application 116a-b in the foreground environment (504). The mobile device 104a-b may receive user input via the application 116a-b to attempt a secure connection with the medical device 102 or may automatically discover and attempt to connect with the medical device 102 using the pairing address or identifier (506). When the mobile device attempts to connect with the medical device 102, the mobile device 104a-b may send a secure connection request that includes an application identifier that identifies the application which is attempting to securely connect with the medical device 102 and/or a mobile device identifier that identifies the mobile device 104a-b which is attempting to securely connect with the medical device 102.

When the application and/or mobile device is validated by the medical device 102, the mobile device 104a-b pairs with the medical device 102 using the pairing address or identifier (508) and establishes a secure connection with the medical device 102 (510). The pairing address or identifier may have been previously stored, pre-configured, discovered or otherwise known, e.g., from a previous pairing or establishment of the secure connection, by the mobile device 104a-b. The mobile device 104a-b uses the pairing address or identifier to pair and establish the secure connection with the medical device 102. In some implementations, the one or more applications 116a-b on the one or more mobile device 104a-b may automatically pair with the medical device 102 when the pairing address or identifier is transmitted or otherwise sent if the one or more applications 116a-b were previously registered with the medical device 102.

When the secure communication channel with the medical device 102 is established, the mobile device 104a-b may send and/or receive high priority communications to and from the medical device 102 (512). The high priority communications may include critical command, critical functions and/or critical notifications related to or associated with the administration of drugs, prescriptions or other treatments. For example, the high priority communications may be a critical command that includes a schedule to administer a drug, such as insulin, along with a dosage or amount. The mobile device 104a-b receives user input that includes the critical command via the user interface 114-b-c and through the application that is being executed. Then, the mobile device 104a-b sends the critical command across the secure communication channel via the network access device 112b-c. In another example, the medical device 102 receives a critical notification, such as an alert that there is no medication available to the medical device 102 or an alert to notify the user that a drug is being or should be administered, via the network access device 112b-c and displays the critical notification on the user interface 114b-c via the application that is running.

Moreover, when the secure communication channel with the medical device 102 is established, the one or more applications 116a-b on the one or more mobile device 104a-b, may obtain the alternate address or identifier (514). The alternate address or identifier may be obtained from the medical device 102 or from the memories 108b-c of the respective mobile device of the one or more mobile device 104a-b running the application. The alternate address or identifier is used to discover the medical device 102 and to receive low priority communications when the one or more applications 116a-b are running in the background environment.

The one or more mobile devices 104a-b may disconnect the secure communication channel (518). When the mobile device 104a-b receives user input that indicates that the user does not intend to engage with the application 116a-b, the one or more mobile devices 104a-b may disconnect the secure communication channel between the application 116a-b and the medical device 102. For example, when the user swipes away from the application 116a-b, switches to another application 116a-b or otherwise closes the application 116a-b, the mobile device 104a-b may sever the secure communication channel between the application 116a-b and the medical device 102.

The one or more applications 116a-b may continue to run in the background environment even when another application 116a-b is in use, when the application 116a-b is closed and/or when the secure communication channel is otherwise disconnected (518). This allows the one or more applications 116a-b and/or the one or more mobile devices 104a-b to discover the medical device 102 when the medical device 102 transmits an advertisement packet using the second address or identifier. Additionally, if the one or more applications 116a-b are switched back into the foreground environment, the one or more applications 116a-b may more quickly connect with the medical device 102 with less latency. Moreover, the one or more mobile devices 104a-b may discover the medical device 102 using the alternate address or identifier and operate or run the one or more applications 116a-b in the background environment to receive or otherwise obtain low priority communications.

The one or more mobile devices 104a-b having the one or more applications 116a-b running in the background environment may obtain the low priority communications from the medical device 102 (520). The low priority communications may include status updates of the software and/or hardware health of the medical device 102, which may be displayed or otherwise presented to a user via the user interface 114b-c.

When the one or more applications 116a-b are in the background environment and do not discover the medical device 102 for a period of time, the one or more applications 116a-b may provide a wake-up signal to the one or more mobile devices 104a-b and enter a sleep state (522). The one or more mobile devices 104a-b may remove the one or more applications 116a-b from the memory 108b-c when the one or more applications 116a-b are in the sleep state (524).

However, the one or more mobile devices 104a-b may discover the medical device 102 using the alternate address or identifier (526) and load the one or more applications 116a-b that the medical device 102 is communicating to with the alternate address or identifier back into the memory 108b-c (528). If the one or more applications 116a-b are loaded back into the memory 108b-c, the one or more applications 116a-b may again operate in the background environment. The communication to the one or more mobile devices 104a-b may be limited by the medical device 102 when using the alternate address or identifier.

Where used throughout the specification and the claims, “at least one of A or B” includes “A” only, “B” only, or “A and B.” Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A medical device, comprising:
a memory;
a network access device having a plurality of hardware device addresses including a first address and a second address and being configured to wirelessly communicate with a mobile device; and
one or more processors coupled to the memory and the network access device and configured to execute instructions stored in the memory and perform operations comprising:
establishing a first secure communication channel between the medical device and an application using the first address, and
transmitting advertising packets to remain discoverable by the application using the second address.

2. The medical device of claim 1, wherein the application is running in a foreground environment of the mobile device when the secure communication channel is established using the first address, wherein the first address is a pairing address.

3. The medical device of claim 1, wherein the operations further comprise:
communicating to a plurality of applications running on a plurality of mobile devices including a first application of the plurality of applications running on a first mobile device of the plurality of mobile devices and a second application of the plurality of applications running on a second mobile device of the plurality of mobile devices using the first address, wherein the application running on the mobile device is the first application and the mobile device is the first mobile device.

4. The medical device of claim 1, wherein the second address is an alternate address and remains unknown to the mobile device but discoverable to the application running on the mobile device.

5. The medical device of claim 1, wherein the operations further comprise:
disconnecting the secure communication channel; and
causing the application on the mobile device to run in a background environment of the mobile device when the application discovers the medical device transmitting the second address.

6. The medical device of claim 1, wherein the plurality of hardware device addresses includes a third address, wherein the operations further comprise:
establishing a second secure communication channel with a second application using the third address, wherein establishing the first secure communication channel and establishing the second communication channel is further based on a whitelist or a blacklist of acceptable or unacceptable addresses, respectively.

7. The medical device of claim 1, wherein transmitting, using the second address, the advertising packets to remain discoverable by the application includes:
periodically transmitting, using the second address, the advertising packets; and
limiting the communication to periodic low priority communications including status updates between the medical device and the application.

8. An embedded device, comprising:
a memory;
a network access device having a plurality of identifiers including a first identifiers and a second identifier and being configured to wirelessly communicate with a first mobile device and a second mobile device; and
one or more processors coupled to the memory and the network access device and configured to execute instructions stored in the memory and perform operations comprising:
establishing a secure communication channel between the embedded device and an application on the first mobile device using the first identifier, transmitting, using the second identifier, advertising packets to remain discoverable by the application,
disconnecting the secure communication channel, and
causing the application on the first mobile device to run in a background environment of the mobile device when the application discovers the embedded device using the second identifier.

9. The embedded device of claim 8, wherein transmitting, using the second address, the advertising packets to remain discoverable by the application includes:
periodically transmitting, using the second address, the advertising packets; and
limiting the communication to periodic low priority communications including status updates between the embedded device and the application that runs in the background using the second address.

10. The embedded device of claim 8, further comprising:
establishing the secure communication channel between the embedded device and a second application on the first mobile device using the first identifier or a third application on the second mobile device using the first identifier.

11. The embedded device of claim 8, further comprising:
transmitting, using the second identifier, advertising packets to remain discoverable by a second application on the first mobile device and a third application on a second mobile device.

12. The embedded device of claim 8, wherein establishing the secure communication includes sending a known pattern recognized by the application on the first mobile device to establish the secure communication between the embedded device and the application.

13. The embedded device of claim 8, wherein the plurality of identifiers are a plurality of universally unique identifiers (UUIDs), wherein the first identifier is a first UUID and the second identifier is a second UUID.

14. The embedded device of claim 8, further comprising:
obtaining an activation request; and
transmitting using the first identifier or the second identifier in response to obtaining the activation request.

15. The embedded device of claim 14, wherein the activation request is at least one of user input including a user selection of a button, a proximity trigger that indicates that a near-field communication field (NFC) is within a threshold distance of the embedded device or a wakeup signal from a real time clock (RTC) after a pre-programmed period of time.

16. The embedded device of claim 8, wherein establishing the secure communication channel between the embedded device and the application on the first mobile device includes:
deriving a unique shared secret during a pairing process; and
computing a message authentication code using the derived unique shared secret to secure a communication channel.

17. A mobile device, comprising:
a memory configured to store a plurality of applications including a first application and a second application, the first application being registered or associated with a first identifier and a second identifier and the second application being registered or associated with a third identifier and a second identifier; and
a processor coupled to the memory configured to execute instructions stored in the memory and perform operations comprising:
executing the first application in the foreground,
establishing a secure communication channel with an embedded device using the first identifier,
sending high priority communications to the embedded device over the secure communication channel, and
discovering the embedded device using the second identifier.

18. The mobile device of claim 17, wherein the operations further comprise:
disconnecting the secure communication channel with the embedded device;
operating the first application in the background environment; and
obtaining low priority communications from the embedded device when the first application is in the background and using the second identifier.

19. The mobile device of claim 18, wherein the operations further comprise:
removing the first application from memory after a period of time of when the first application is in the background environment; and
loading the first application from memory into the background environment when the embedded device is discovered.

20. The mobile device of claim 17, wherein the first identifier is a first pairing address or a first universally unique identifier (UUID) and the second identifier is a second alternating address or a second UUID.
